(19) United States
(12) Patent Application Publication
(10) Pub. No.: US 2002/0156336 A1
(43) Pub. Date: Oct. 24, 2002

(54) Method for continuous detoxification of poisonous agent or toxic chemical compound, or soil contaminated by said poisonous agent and/or said toxic chemical compound

(76) Inventor: Zinovy Petrovich Pak, Moscow (RU)

Correspondence Address: KENYON & KENYON, 1500 K Street, N.W., Suite 700, Washington, DC, 20005, US

(21) Appl. No.: 10/122,383

(22) Filed: Apr. 16, 2002

(30) Foreign Application Priority Data
Apr. 18, 2001 (RU) 2001110324

(51) Int. Cl. A62D 3/00

(52) U.S. Cl. 588/205

(57) ABSTRACT

The invention relates to field of elimination of chemical weapon charged with warfare chemical poisonous agents.

Method for continuous detoxification of poisonous substance or toxic chemical compound, or soil contaminated by said poisonous substance, and/or said toxic chemical compound, includes, essentially, providing a first stream of nucleophilic agent; directing said first stream via a pipe line in a first inlet duct and, then, to blending zone of an injector-mixer under pressure, in limits from about 2 kgf/sm² to about 10 kgfsm², resulting in producing underpressure in a second inlet duct of said injector-mixer in limits from about 0.15 kgf/sm² to about 0.8 kgf/sm²; providing a second stream of said poisonous substance or said toxic chemical compound, or said soil contaminated by said poisonous substance and/or said toxic chemical compound due to said previously obtained underpressure; directing said second stream into said second inlet duct, and then to said blending zone of said injector-mixer; continuous blending of said first stream and said second stream in said blending zone of said injector-mixer, resulting in receiving deactivated mixture of said poisonous substance or said toxic chemical compound, or said soil contaminated by said poisonous substance and/or said toxic chemical compound, and said nucleophilic agent; removal of said previously obtained deactivated mixture from said blending zone, and then from said injector-mixer through outlet canal thereof in the corresponding outlet pipe line.

### FIELD OF THE INVENTION

The present invention relates to a field of elimination of chemical weapon charged with chemical warfare poisonous agents, in particular, organoarsenic, organophosphorus and organochlorine poisonous agents, and also to a field of detoxification of chemical warfare agents withdrawn from the ammunition filled thereby, toxic chemical compounds, waste products and soils contaminated thereby. The present invention relates to detoxification of both stocks of chemical ammunition charged with poisonous agents, and reserves of poisonous agents, toxic chemical compounds and soils contaminated thereby. The present invention relates in particular to a method for continuous detoxification of poisonous agent or toxic chemical compound, or soil contaminated by said poisonous agent and/or said toxic chemical compound.

Elimination of stocks of chemical weapon and toxic chemical compounds is an extremely actual and complicated problem often requiring developing of individual, unique technologies. Any proposed technology should correspond to a number of rigid conditions:

complete and guaranteed safety,

absence of risk connected with transport, unloading and preparation of the components of chemical weapon for the elimination process,

prevention of contact with environment of the initial components or products of decomposition thereof,

high reliability of all stages of the technological process,

low level of economical expenditures.

Leading countries of the world—Russia, USA, Germany, Japan, Great Britain, France—being actually developers of the chemical weapon—have dealt with the problem of elimination thereof since the time of World War II.

Numerous methods for elimination of chemical warfare agents and chemical weapon on the basis thereof are known in the art. This is both primitive dumping in the deep water (or burring deep in the earth), burning and pyrolysis, including high-temperature pyrolysis, burning in plasma, simple pouring out poisonous agents in an oven; elimination poisonous agents by explosion, including explosion of nuclear weapon (1. Author: Dr. Grehem Pearson, “Elimination of chemical weapon in the Great Britain”, published in the Russian Chemical Journal, 1995, volume XXXIX, No. 4, pp. 113-120.; 2. Authors: Koshelev V. M., Zhdanov V. A., et al. “American Developments of Methods for Elimination of Chemical Weapon”, published in the Russian Chemical Journal, 1995, volume XXXIX, No. 4, pp. 31-36.).

It is presently apparent, that the listed measures are not only doubtful from the point of view of ecological safety, but also are completely inadmissible and inconsistent with national and international nature protection legislation. Methods for elimination of poisonous agents based on direct burning of poisonous agents in ovens are connected with necessary further purification of end gas and dumping of solid residues. Formation and buildup of huge amount of highly toxic waste products—solid, liquid and gaseous—constitutes an appreciable ecological load on environment. In particular, concerning the lewisite, it is connected with buildup of great amount of waste products containing arsenite of iron. Besides, the method of burning assumes use of high temperatures and formation of acidic products in result of burning (HF, H₃PO₄, P₂O₅, HCl, SO₂, N₂O₅, etc.), that can result in premature failure of fireproof lining of the burning ovens and, consequently, in emission of poisonous agents in atmosphere of manufacturing facilities.

There are known methods for biological detoxification of poisonous agents, that is using of microorganisms for elimination of poisonous agents (1. Authors: Petrov S. V., Korjakin Yu. N. et al. “Biotechnology in Resolving the Problem of Chemical Weapon Elimination”, published in the Russian Chemical Journal, 1995, volume XXXIX, No. 4, pp. 18-20.; 2. Authors: Varfolomeev S. D., Kurochkin I. N. et al. “New Technological Approach to Elimination of Chemical Weapon. Complete Biological Degradation of Chemical ammunition”, published in the Russian Chemical Journal, 1995, volume XXXIX, No. 4, pp. 20-24.)

The method for biological degradation of chemical weapon favorably differs from the methods listed above. However, a method for chemical detoxification precedes biological detoxification at high concentrations of toxic agent and elimination of pure poisonous agents.

Presently, practically in most cases, chemical methods are preferable for detoxification of poisonous agents and chemical weapon on the basis thereof

The problem of elimination of poisonous agents is especially actual for Russia that has significant stocks of lewisite (and lewisite is stored not only in shells, but also in large containers). The articles (1. Authors: S. Beker, K. Machek, E. Shteldt. “Ecologically Clean Decontamination of Supertoxic Arsenic-Containing Substances with Deriving of High-Clean Arsenic”, published in—the Russian Chemical Journal, 1995, volume XXXIX, No. 4, pp. 58-61; 2. Authors: G. B. H. Machils et al. “Elimination of Lewisite (Comparison of Three Methods)” published in the Russian Chemical Journal, 1995, volume XXXIX, No. 4, pp. 37- 42) represent a review and analysis of possible Russian and foreign methods for elimination of organoarsenic poisonous agents. In 1992 the Commission of Experts at the President of the Russian Federation on Priority Processing Technologies of Lewisite preferred chemical methods of deactivation (Authors: Petrov S. V. “Expert Estimation of Elimination Technologies of Lewisite Stocks”, published in the Russian Chemical Journal, 1995, volume XXXIX, No. 4, p. 4), thus the methods eliminating formation of waste products and providing utilization of arsenic contained in lewisite—alkaline hydrolysis with electrolysis, alcoholysis, ammonolysis and hydrogenolysis, were defined as the priority methods. Such methods for decontamination of lewisite as its fusion with sulfur, polymerization with methacrylic glycolate, high temperature acidification, chlorination and so forth, were recognized in 1992 as unacceptable from the point of view of technological effectiveness of the process, technical and ecological safety.

However, the methods selected as the priority methods also have deficiencies. The method of alkaline hydrolysis (an exchange reaction between substance and water) with consequent electrolysis of reaction masses is characterized by the greatest ecological safety and the best specific technical and economic indexes, that was a reason for designation of this method as a priority technique for utilization of, for example, lewisite.

In practice, chemical hydrolysis is an obligatory stage of detoxification for all poisonous agents, and this is a precursor stage to consequent utilization of especially scarce metals such as arsenic.

Analysis of patents on detoxification of poisonous agents sowed large variety of the technique from dumping ammunition in sea for durable hydrolysis of poisonous agents by seawater, to simple poring of water in the ammunition and consequent hydrolysis during about 100 day depending on the type of poisonous agents, see patents of the Russian Federation 2042368 and 2087171; ageing of poisonous agents with water within 6-8 hours and consequent boiling within 5-6 hours of hydrolysate with aliphatic alcohols, see patent of the Russian Federation 2056120; vapor hydrolysis of poisonous substance at elevated temperature, see patent DE 3429346 C2.

The method for alkaline hydrolysis is also widely represented in the patents (in particular, see patents of the Russian Federation 2099116 and 2071799; patent DE 3622242 C2; U.S. Pat. U.S. 5,545,799; publication of international patent application WO 9637264 A1), including: consequent heat treatment of the reaction mixture at elevated temperature (up to 400° C.), see patent of the Russian Federation 2123368; hydrolysis by alkalis at temperature 600-800° C., see patent DE 3447337 C2; aqueous hydrolysis at presence of alkalinous catalyzers at temperature 350° C. and pressure up to 100 MPa, see specification of international patent application WO 9634662 A1).

The process for detoxification of lewisite by interaction with ammonia at temperature 500-800° C. can be considered as a process based on hydrolysis (see patent of the Russian Federation 2096057). The process of detoxification of organoarsenic substances by formic acid at elevated temperature (135-145° C.) and ageing within 4 hours is based on acid hydrolysis (see patent of the Russian Federation 2129456).

Processing of poisonous agents by alkali metals with consequent heating of the reaction product can not be considered as a pure hydrolysis, (see patent of the Russian Federation 2073543, patent DE 19501597 C1), though emergence of water at heating, naturally, results in alkaline hydrolysis at some extent.

Common essential deficiencies of the methods of chemical detoxification disclosed in the above mentioned patents are: either periodic character of the used techniques, or necessity of high temperature to shorten time of detoxification, or large-sized instrumentation containing poisonous substance in the initial state in dangerous densities for durable time—up to several hours. Extremely slow speed of hydrolysis at low temperatures is a particular reason for this, and the process itself is labor-consuming, demanding capacious equipment and large consumption of chemicals.

Patents of the Russian Federation 2025145, 2071799 or 2099116 are the closest art to the method proposed by us. Chemical methods for detoxification of lewisite, sarin, Vx are also described in the article: Authors: Z. Franke, P. Franz, V. Varnke “Chemistry of Poisoning Substances” volume 2, Moscow, publishing house—“Chemistry”, 1973, pp. 280, 302, 320, 339, 341, 343. According to this document, detoxification is carried out due to alkaline hydrolysis in reactors with agitator and jacket for thermal exchange. The process takes place at optimal temperature not less than 1.5-2 hours with large loss of time for heating of alkaline solution and necessary period of ageing of the reaction masses. Detoxification is also carried out due to alkaline hydrolysis catalyzed by primary amines. Processes are organized on periodic or semi-periodic layout, but also in large volume reactors.

### SUMMARY OF THE INVENTION

It is an object of the present invention to develop a continuous and secure method for detoxification of poisonous agents and toxic chemical compounds.

This object is achieved, according to the present invention, due to chemical decomposition of poisonous agents, toxic chemical compounds or mixtures thereof and transformation thereof into non-toxic compounds, for example, due to continuous hydrolysis of poisonous agents with transformation thereof into nonhazardous compounds. If necessary, the obtained reaction solutions can be further utilized for recovery of valuable chemical products.

The method for continuous detoxification of poisonous substance or toxic chemical compound, or soil contaminated by said poisonous substance, and/or said toxic chemical compound, provides, essentially, the following stages:

(a) providing a first stream of nucleophilic agent;

(b) directing said first stream via a pipe line into a first inlet duct, and then to a blending zone of an injector-mixer under pressure from about 2 kgf/sm² to about 10 kgf/sm², resulting in creation of underpressure in a second inlet duct of said injector-mixer in limits from about 0.15 kgf/sm² to about 0.8 kgf/sm²;

(c) providing a second stream of said poisonous substance or said toxic chemical compound, or said soil contaminated by said poisonous substance and/or said toxic chemical compound, due to said underpressure produced at stage (b);

(d) directing said second stream into said second inlet duct, and then to said blending zone of said injector-mixer;

(e) continuous blending said first stream and said second stream in said blending zone of said injector-mixer, resulting in receiving of deactivated mixture of said poisonous substance, or said toxic chemical compound, or said soil contaminated by said poisonous substance and/or said toxic chemical compound, and said nucleophilic agent;

(f) removal of said deactivated mixture obtained at stage (e) from said blending zone, and then from said injector-mixer through an outlet canal thereof into corresponding outlet pipe line.

A substance selected from the group of water; solutions of metals hydroxides and/or carbonates thereof, hypochlorites, hypophosphates of metals of groups 1, 2 of the Periodic System of Chemical Elements or ammonia; ammonium solutions and/or aliphatic alcohols; and/or alkanolamine ethers or salts thereof; and/or mixtures thereof with hydroxides of the above-stated metals; inorganic or organic acids, and/or solutions thereof, and/or mixtures thereof with salts of the above-stated metals; and/or mixtures thereof, is most preferable to use as said nucleophilic agent.

In order to shorten the time of detoxification said nucleophilic agent should be preheated to the temperature in limits from about 400° C. to about 150° C. before feeding thereof to said blending zone of said injector-mixer.

An alternative method provides feeding overheated steam to said blending zone of said injector-mixer via a pipe line being reserve for said first pipe line, simultaneously with said nucleophilic agent, for intensification of the detoxification process.

The best effect of detoxification is obtained when a dissolvent selected from the group of aliphatic and/or cyclic ketones; and/or monoatomic, and/or diatomic, and/or cyclic alcohols; and/or aliphatic ethers; esters on the basis of alcohols and mineral or organic acids; and/or halogen containing dissolvents; and/or hydrocarbon solvents; and/or mixtures thereof, is fed simultaneously with said nucleophilic agent via one of said first inlet duct or second inlet duct of said injector-mixer.

Preferably, in course of detoxification of the poisonous substance, said second inlet duct should be directly connected with inlet mouth of the container storing said poisonous substance of the ammunition, that provides the safest withdrawal of said poisonous substance from said container of said ammunition, and direct feeding of said poisonous substance to said blending zone of said injector-mixer.

In course of detoxification the soil contaminated by said poisonous substance and/or by said toxic chemical compound is mixed with water, before feeding thereof into said second inlet duct of said injector-mixer, to give pulp state to said soil.

It would be expedient to install said injector-mixer on a mobile platform to carry out the above method for continuous detoxification.

The subject of the present invention is also a method for detoxification of poisonous substance or toxic chemical compound contained in the air of a compartment, where said detoxification is carried out, including, essentially, the following stages:

(a) providing a first stream of nucleophilic agent;

(b) directing said first stream via a pipe line into a first inlet duct and then, to a blending zone of at least one ejector under pressure of from about 2 kgf/sm² to about 10 kgf/sm², resulting in forming of underpressure in a second inlet duct of said ejector in limits from about 0.15 kgf/sm² to about 0.8 kgf/sm²;

(c) providing a second stream of said air contaminated by poisonous substance or said toxic chemical compound, due to said underpressure produced at stage (b);

(d) directing said second stream from said compartment into said second inlet duct and then, to said blending zone of said ejector;

(e) continuous blending said first stream and said second stream in said blending zone of said ejector, resulting in receiving of deactivated mixture of said poisonous substance or said toxic chemical compound, purified air and said nucleophilic agent, and products of detoxification;

(f) removal said deactivated mixture obtained at stage (e) from said blending zone and then, from said ejector through an outlet canal thereof into corresponding said pipe line;

(g) feeding the deactivated mixture obtained at stage (f) via an outlet pipe line into a separator and a spray catcher;

(h) separation of said purified air from the mixture of said nucleophilic agent, products of detoxification and drops thereof;

(i) continuous ejection of said purified air in the atmosphere;

(j) returning said nucleophilic agent and said obtained products of detoxification to stage (e).

A substance selected from the group of water; solutions of metals hydroxides and/or carbonates thereof, hypochlorites, hypophosphates of metals of groups 1, 2 of the Periodic System of Chemical Elements or ammonia; ammonium solutions and/or aliphatic alcohols; and/or alkanolamine ethers or salts thereof; and/or mixtures thereof with hydroxides of the above-stated metals; inorganic or organic acids, and/or solutions thereof, and/or mixtures thereof with salts of the above-stated metals; and/or mixtures thereof, is most preferable to use as said nucleophilic agent in the given method.

Overheated steam is fed simultaneously with said nucleophilic agent to said blending zone of said ejector via a pipe line being reserve for said first pipe line, for intensification of detoxification process.

In order to shorten the time of detoxification, said nucleophilic agent, before feeding thereof to said blending zone of said ejector, is preheated to temperature in limits from about 400° C. to about 150° C.

The greatest detoxification effect is achieved when a dissolvent selected from the group of aliphatic and/or cyclic ketones; and/or monoatomic, and/or diatomic, and/or cyclic alcohols; and/or aliphatic ethers; esters on the basis of alcohols and mineral or organic acids; and/or halogen containing dissolvents; and/or hydrocarbon solvents; and/or mixtures thereof, is fed simultaneously with said nucleophilic agent via one of said first inlet duct or second inlet duct of said injector-mixer

Thus:

the method is based on continuous blending of chemical reagents and detoxification in an injector (injector-mixer) and lateral pipe lines during the time of residence of solutions therein, with transfer of finished products and chemical solutions in a cooler and/or accumulative containers;

the method for detoxification of poisonous agents is carried out by continuous nucleophilic substitution in at least one injector (injector-mixer) due to ejection charging of poisonous agents into injector, using applicable nucleophilic agents as a working liquid;

water; solutions of hydroxides of metals and/or carbonates, hypochlorites, hypophosphates thereof; hypophosphates of metals or ammonia; ammonia; alkanols, aliphatic alcohols and/or alkanolamine ethers or salts, or mixtures thereof with hydroxides of metals; inorganic or organic acids, or solutions thereof, and/or mixtures thereof with salts; or mixtures thereof, can be used as nucleophilic agents;

poisonous substance is ejected by action of underpressure at inlet to the injector from about 0.15 kgf/sm² to about 0.8 kgf/sm², in amount not less than 50 kg/hour, because of, for example, continuous feeding of nucleophilic agent by a dosing pump under pressure from about 2 kgf/sm² to about 10 kgf/sm², thus because of the heat effect of reaction and temperature of the working liquid, temperature in the injector is maintained from about +40° C. to about +150° C. It was confirmed, that overheated steam together with the working liquid can be fed in the injector simultaneously with the nucleophilic agent;

the method provides possibility of ejection in the injector of products of incomplete processing for the phase of repetitive additional detoxification;

the method for continuous detoxification may be applied for phosphoprous-containing and phosphoprous-sulfur-containing chemical warfare agents of the type of tabun, sarin, soman, Vx, mustard gas; arsenic-containing chemical warfare agents such as lewisite, adamsite, agent “blue”, diphenyl-As-cyanide, diphenyl (or phenyl-As-chloride); or mixtures thereof;

the method is characterized in that, the poisonous substance can be ejected directly from the ammunition because of use of flexible stock lines, and also, optionally, by applying additional dissolvents;

in order to increase the safety of the process the method provides simultaneous and independent constant producing of underpressure in course of ejection of poisonous agents in the working rooms, places of withdrawal of chemical warfare agents from ammunition by the main injector, which is provided with detoxification, and additional injectors producing underpressure in the working rooms and on charging operation—for entrapping and detoxification of volatile and aerosol particles of chemical warfare agents and/or toxic chemical compounds and mixtures thereof percolated in the working rooms; thus the working injector and additional injectors because of continuous feeding of the working liquid - circulation of nucleophilic agents—work in a closed cycle.

Ecological cleanness and safety of the technological process at all stages are, naturally, the main criteria for selection and optimizations of technique for elimination of stocks of poisonous agents. The claimed method provides all these criteria of safety of chemical technology for detoxification, including sharp shortening of time of chemical elimination of poisonous substance.

In the claimed method detoxification of poisonous substance is organized on continuous layout, based on the process of continuous blending of at least two flows of liquids at different pressure with forming of a blended stream of intermediate pressure, thus all chemical processes of detoxification are carried out in this stream at optimal temperature and during blending, and transport. Thus, the continuously heated stream of the nucleophilic agent fed under pressure by a dosing pump is used as a working liquid of the injector, and the poisonous substance is an ejection fluid being vacuum ejected, for example, directly from an ammunition. We used the layout and construction of the so-called glycols nitration injector method (phases of nitration, cooling and separation), established for production of nitroglycerine in the Federal Center of Dual Technologies “Soyuz” (Dzerzhinsky city, Moscow region, Russia) as a model of working detoxification assembly.

The proposed method has a number essential qualitative advantages compared to the known processes:

continuity of the process;

possibility of ejection of the poisonous substance directly from ammunition;

minimal loading of poisonous substance in the apparatuses;

instantaneous reaching of the required mode of operation of the detoxification phase and possibility of its stopping, or repetitive (additional) processing;

possibility of exact providing of the required physical, and chemical, and technological parameters of reagents for complete and guaranteed detoxification due to application of modem methods of automation of the hazardous chemical process;

safety of the process provided both by drawing liquid and vapors of the poisonous substance in the apparatus, by small volumes of the equipment, practically arbitrary required output, and evacuation (production of underpressure) in the working room with entrapping and detoxification of vapors and microdroplets of the poisonous substance.

### DETAILED DESCRIPTION OF THE INVENTION

Examples of practical realization of the invention with detoxification of lewisite, soman, sarin, Vx agent are described below. The method was experimentally checked for detoxification of mixtures of poisonous agents, as well as for detoxification of soils, grounds and waste products from burials and other contaminated places. In the latter case, naturally, the ground (soil) was charged in the reactor, dispersed by water and was drawn in the injector in form of a fluid constantly stirring pulp. Optimal temperature parameters of such process and constitution of the mixture of nucleophilic agents is defined, naturally, by composition of the contaminated earth (grounds, soils, waste products).

Detoxification process of sarin and soman was tested by processing thereof by solution of monoethanolamine containing 20±20 % of water. In the model glass or metallic injector was made as the glycerin nitration type injector, but with productiveness of 15 kg/hour, determined by a dosing pump (vacuum from about 0.15 kgf/sm² to about 5 kgf/sm², pressure of the working liquid up to about 5 kg/sm²). Solution of monoethanolamine with water was used as working liquid, and sarin or soman were processed liquid. In the reception camera of the injector the working liquid is contacted, caught and mixed with ejected and liable to detoxifications sarin, soman (or mixtures thereof) and is fed after detoxification by pressure pipe into a cooler and further into an accumulating container.

Pneumatic clamps allowed to eject the poisonous substance only after feeding of the working liquid reached a prescribed mode. For the period of adjustment of the process the layout was provided with a possibility of ejection chemical solutions from the accumulating container back to the injector, according to a close cycle, with sampling the solution for analysis and possible retreatment.

Processes for both substances: sarin and soman, were performed at temperature, for example, 40° C., according to the charts of chemical reactions I and II:

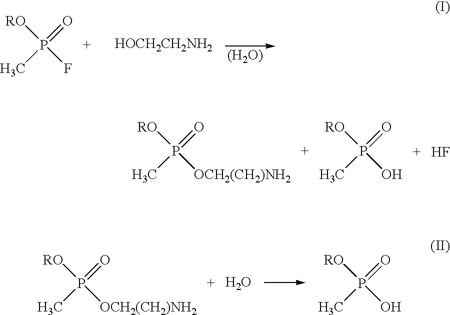

and carried out at the moment of blending in the injector, and were so quick, that variation of density of poisonous substance in the reaction solutions of detoxified substances could not be defined by the direct method. It was noted, that the process flowed stably, and rate of the hydrolysis was mainly defined not by the temperature, but by proportion of reagents and composition of monoethanolamine and water. In the experiments, proportion of the substances exposed to detoxification to monoethanolamine varied from 1:1 to 1:3.5. Thus, depending on the initial temperature of reagents (from +10°C. to +50° C.) due to the heating effects (72±2 kJ on 100 g for sarin, 66 kJ on 100 g for soman) temperature of the reaction mass increased within 10-20 seconds, without cooling of the injector, up to the temperature from +50° C. to +180° C., resulting in some cases in boiling of the reaction mass. It was checked introducing of water in monoethanolamine in amount up to 0.6 mols on 1.0 mol of monoethanolamine.

### Detoxification of Lewisite

Technical grade lewisite being a mixture of α-and a β-lewisite with admixture of arsenic trichloride and organic gums, according to Russian patents 2071799 and 2099116 may be subjected to detoxification by aqueous solutions of alkalis though the admixtures are hardly bound by aqueous solutions of alkalis. Cis-isomer of α-lewisite transforms at heating in trans-isomer, and vinyl chloride or acetylene are gaseous products of hydrolysis thereof. Both isomers evolve acetylene at hydrolysis in conditions of temperatures higher then 40° C. (see the chart of chemical reaction III):

(ClCH═CH)₂ArCl+6NaOH→2 HC≡CH↑+Na₂ArO₃+3NaCl+3H₂O (III)

In the model detoxification plant of technical lewisite 20-30% aqueous solution of sodium hydroxide pumped by a dosing pump with temperature from about +60° C. to about +130° C. was tested as a working liquid. Pressure of the working liquid was maintained in a range from about 3 kgf/sm² to about 6 kgf/sm², underpressure before the injector was from about 0.13 kgf/sm² to about 0.7 kgf/sm². Due to the heating effect of hydrolysis reaction, rise of temperature of the alkaline solution higher than +120° C. often was not required because of great amount of water necessary for cooling of the reaction solutions and effluent gas, and additional operation for its washing in the second injector from arsenic-containing volatile impurities. Decrease of temperature of the alkaline solution lower than +90° C. required cycling of the flows with repetitive feeding of the obtained reaction solutions in the first injector with partial admixing thereof due to vacuum (simultaneous charging) together with the initial technical lewisite. The amount of acetylene extracted during detoxification of lewisite was a reliable method for estimation of completeness of the operation. The method for estimation of the alkali contents in the working solutions after the cooler was used as a doubling method for verification.

Effectiveness of simultaneous feeding of overheated steam as a part of the working liquid was checked and demonstrated, though operation of the alkali solution dosing pump required constant attention and monitoring because of rise of density of the required alkali solution.

### Vx Detoxification Process

Improvement of Vx detoxification process was performed at use in the injector, as the working solution, of a solution based on potassium isobutylate in amount of 30% mas. The process flowed, basically, in two stages according to the chart of chemical reaction IV:

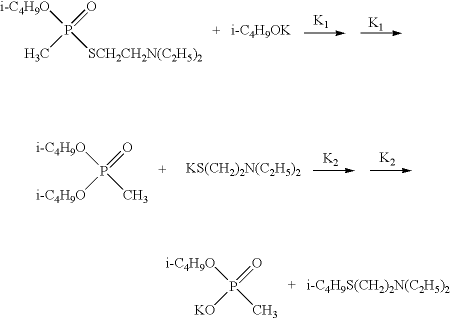

Interaction of Vx with potassium isobutylate at temperature higher than 60° C. was so quick, that direct methods for defining toxic agent concentration in the working solutions after injection were practically not possible. Pressure of the working liquid was maintained in a range from about 3 kgf/sm² to about 6 kgf/sm², level of underpressure at the injector was checked in an interval from about 0.10 kgf/sm² to about 0.8 kgf/sm². It was, however, noted slow rate of the second stage of interaction of potassium mercaptilate with diisobutyl ether of methylphosphonic acid at temperature about 70° C., and at temperature lower than +40° C. it practically stopped. Due to the summary heating effect of two stages of about 103±3 kJ/M, the reaction mass was heated-up at quick blending of the working solution with poisonous substance in the injector and potassium salt was quickly formed.

It was experimentally checked, with confirming of effectiveness, substitution of water jet injected system for vent system with absorbing filters in order to heighten safety of the process provided simultaneous and independent constant producing of underpressure at ejection and in working rooms, places of withdrawal of chemical warfare agents from ammunition. Thus, this provides work of both the main injector performing detoxification, and the additional, at least one, ejector creating underpressure in the working rooms and in operation of charging and entrapping, with simultaneous detoxification, of volatile and aerosol particles of chemical warfare agents and/or toxic chemical compounds and mixtures thereof due to continuous feeding and circulations of nucleophilic agents in a close cycle.

1. Method for continuous detoxification of poisonous substance or toxic chemical compound, or soil contaminated by said poisonous substance and/or by said toxic chemical compound, providing, essentially, the following stages:
(a) providing a first stream of nucleophilic agent;
(b) directing said first stream via a pipe line into a first inlet duct, and then to a blending zone of an injector-mixer under pressure in limits from about 2 kgf/sm² to about 10 kg/sm², resulting in creation of underpressure in a second inlet duct of said injector-mixer in limits from about 0.15 kgf/sm² to about 0.8 kg sm²;
(c) providing a second stream of said poisonous substance or said toxic chemical compound, or said soil contaminated by said poisonous substance and/or said toxic chemical compound, due to said underpressure produced at stage (b);
(d) directing said second stream into said second inlet duct, and then to said blending zone of said injector-mixer;
(e) continuous blending said first stream and said second stream in said blending zone of said injector-mixer, resulting in receiving of deactivated mixture of said poisonous substance, or said toxic chemical compound, or said soil contaminated by said poisonous substance and/or said toxic chemical compound, and said nucleophilic agent;
(f) removal of said deactivated mixture obtained at stage (e) from said blending zone, and then from said injector-mixer through an outlet canal thereof into corresponding outlet pipe line.

2. Method according to claim 1, wherein a substance selected from the group of water; solutions of metals hydroxides and/or carbonates thereof, hypochlorites, hypophosphates of metals of groups 1, 2 of the Periodic System of Chemical Elements or ammonia; ammonium solutions and/or aliphatic alcohols; and/or alkanolamine ethers or salts thereof; and/or mixtures thereof with hydroxides of the above-stated metals; inorganic or organic acids, and/or solutions thereof, and/or mixtures thereof with salts of the above-stated metals; and/or mixtures thereof, is most preferable to use as said nucleophilic agent.

3. Method according to claim 1, wherein said nucleophilic agent, before feeding thereof to said blending zone of said injector-mixer, is preheated to the temperature in limits from about 400° C. to about 150° C. for shortening the time of detoxification,.

4. Method according to claim 1, wherein overheated water steam is fed to said blending zone of said injector-mixer via a pipe line being reserve for said first pipe line, simultaneously with said nucleophilic agent, for intensification of the detoxification process.

5. Method according to claim 1, wherein a dissolvent selected from the group of aliphatic and/or cyclic ketones; and/or monoatomic, and/or diatomic, and/or cyclic alcohols; and/or aliphatic ethers; esters on the basis of alcohols and mineral or organic acids; and/or halogen containing dissolvents; and/or hydrocarbon solvents; and/or mixtures thereof, is fed simultaneously with said nucleophilic agent via one of said first inlet duct or second inlet duct of said injector-mixer.

6. Method according to claim 1, wherein said second inlet duct is directly connected with inlet mouth of the container storing said poisonous substance of an ammunition for the safest withdrawal of said poisonous substance from said container of said ammunition, and direct feeding of said poisonous substance to said blending zone of said injector-mixer.

7. Method according to claim 1, wherein said soil contaminated by said poisonous substance and/or by said toxic chemical compound is mixed with water, before feeding thereof into said second inlet duct of said injector-mixer, to give pulp state to said soil.

8. Method according to claim 1, wherein said injector-mixer for continuous detoxification is installed on a mobile platform.

9. Method for detoxification of poisonous substance or toxic chemical compound contained in the air of a compartment, wherein said detoxification is carried out, including, essentially, the following stages:
(a) providing a first stream of nucleophilic agent;
(b) directing said first stream via a pipe line into a first inlet duct and then, to a blending zone of at least one ejector under pressure of from about 2 kgf/sm² to about 10 kgf/sm², resulting in forming of underpressure in a second inlet duct of said ejector in limits from about 0.15 kgf/sm² to about 0.8 kgf/sm²;
(c) providing a second stream of said air contaminated by poisonous substance or said toxic chemical compound, due to said underpressure produced at stage (b);
(d) directing said second stream from said compartment into said second inlet duct, and then to said blending zone of said ejector;
(e) continuous blending said first stream and said second stream in said blending zone of said ejector, resulting in receiving of deactivated mixture of said poisonous substance or said toxic chemical compound, purified air and said nucleophilic agent, and products of detoxification;
(f) removal said deactivated mixture obtained at stage (e) from said blending zone, and then from said ejector through outlet canal thereof into corresponding said pipe line;
(g) feeding the deactivated mixture obtained at stage (f) via an outlet pipe line into a separator and a spray catcher;
(h) separation of said purified air from the mixture of said nucleophilic agent, products of detoxification and drops thereof;
(i) continuous ejection of said purified air in the atmosphere;
(j) returning said nucleophilic agent and said obtained products of detoxification to stage (e).

10. Method according to claim 9, wherein a substance selected from the group of water; solutions of metals hydroxides and/or carbonates thereof, hypochlorites, hypophosphates of metals of groups 1, 2 of the Periodic System of Chemical Elements or ammonia; ammonium solutions and/or aliphatic alcohols; and/or alkanolamine ethers or salts thereof; and/or mixtures thereof with hydroxides of the above-stated metals; inorganic or organic acids, and/or solutions thereof, and/or mixtures thereof with salts of the above-stated metals; and/or mixtures thereof, is used as said nucleophilic agent.

11. Method according to claim 9, wherein overheated steam is fed simultaneously with said nucleophilic agent to said blending zone of said ejector by a pipe line being reserve for said first pipe line, for intensification of detoxification process.

12. Method according to claim 9, wherein said nucleophilic agent, before feeding thereof to said blending zone of said ejector, in order to shorten the time of detoxification, is preheated to the temperature in limits from about 400° C. to about 150° C.

13. Method according to claim 9, wherein a dissolvent selected from the group of aliphatic and/or cyclic ketones; and/or monoatomic, and/or diatomic, and/or cyclic alcohols; and/or aliphatic ethers; esters on the basis of alcohols and mineral or organic acids; and/or halogen containing dissolvents; and/or hydrocarbon solvents; and/or mixtures thereof, is fed simultaneously with said nucleophilic agent via one of said first inlet duct or second inlet duct of said injector-mixer.
